(19) United States
(12) Patent Application Publication
(10) Pub. No.: US 2004/0176865 A1
(43) Pub. Date: Sep. 9, 2004

(54) Manual production pacemaker

(76) Inventors: Brian K. Breiholz, Burlington, KY (US); Toru Moritake, Union, KY (US); Yoshihito Kondo, Nisshin (JP)

Correspondence Address: DINSMORE & SHOHL, LLP, 1900 CHEMED CENTER, 255 EAST FIFTH STREET, CINCINNATI, OH, 45202, US

(21) Appl. No.: 10/382,824

(22) Filed: Mar. 6, 2003

(51) Int. Cl. G06F 19/00

(52) U.S. Cl. 700/111

(57) ABSTRACT

A pacing apparatus for use in a manual production line features a sensory output configured to provide varying sensory cues scaled to a desired task achievement period. The pacing apparatus may also include a sensory display having a plurality of lights configured to provide varying visual cues scaled to a desired task achievement period. A system for pacing workers in a manual production line may include means for entering data corresponding to a desired task achievement period and means for providing varying sensory cues scaled to the desired task achievement period.

### FIELD OF THE INVENTION

This invention relates to an apparatus for use in a manual production situation. More particularly, the invention relates to an apparatus for pacing workers in a production line by providing varying visual cues scaled to a desired task achievement period.

### BACKGROUND OF THE INVENTION

Basic pacemakers for pacing manufacturing processes such as automobile production processing and production line workers are known in the art. Such pacemakers include units positioned at a location adjacent the production line worker, or the work station, and include, for example, a counter-type timing device. The counter may include an LCD display preset with a target amount of time (i.e. 45 seconds) for completion of a particular part or process (otherwise known as a cycle). Upon commencement of the cycle, the counter counts down from the preset time to 0.

Another counter-type timing device may include a first LCD display preset with a target amount of time (i.e. 45 seconds) and a second LCD display indicating the amount of time remaining to complete the cycle within that target. Upon commencement of the cycle, the second LCD display counts down from the preset time to 0, while the first LCD display remains constant to display the total time allotted for the cycle.

The present invention recognizes and addresses some of the problems with such counter-type timing devices. First, issues arise with such counter-type devices in that the production line worker is required to take his/her eyes off of the workpiece on which he/she is working in order to view the counter. In addition, the worker must perform a series of mental processes in order to calculate how much time he/she has remaining for completion of the cycle or how much time he/she has already spent in the cycle. As a result, the production line worker may lose precious seconds of work, time and/or focus in viewing the counter and exchanging mental processes for interpreting the time of the counter.

As such, there is a desire for a pacemaking apparatus for use in a manual production line that allows a worker to more easily keep track of the amount of time remaining in a cycle.

### SUMMARY OF THE INVENTION

Accordingly, the present invention is intended to address and obviate problems and shortcomings and otherwise improve previous manufacturing cell and assembly line pacemakers.

To achieve the foregoing and other objects and in accordance with the exemplary embodiments of the present invention, a pacing apparatus for use in a manual production line comprises a sensory output. The sensory output may be configured to provide varying sensory cues scaled to a desired task achievement period and corresponding to relative portions of the achievement period.

To still further achieve the foregoing and other objects in accordance with other exemplary embodiments of the present invention, a system for pacing workers in a manual production line comprises means for entering data corresponding to a desired task achievement period. In addition, the system may also comprise means for providing varying sensory cues scaled to the desired task achievement period and corresponding to relative portions of the achievement period.

To yet further achieve the foregoing and other objects in accordance with other exemplary embodiments of the present invention, a method for pacing a manual production task such as in a manufacturing production line comprises the steps of providing a pacing apparatus comprising a sensory output configured to provide varying sensory cues scaled to a desired task achievement period and corresponding to relative portions of the achievement period, setting the sensory output to provide particular varying sensory cues corresponding to particular segments of a task achievement period, starting the pacing apparatus at the commencement of the task, providing varying sensory cues corresponding to relative portions of the achievement period whereby a worker can sense where in the period he or she is relative to how much work remains to complete the task and stopping the pacing apparatus upon completion of the task.

Still other embodiments, combinations, advantages and objects of the present invention will become apparent to those skilled in the art from the following descriptions wherein there are shown and described alternative exemplary embodiments of this invention for illustration purposes. As will be realized, the invention is capable of other different aspects, objects and embodiments all without departing from the scope of the invention. Accordingly, the drawings, objects, and description should be regarded as illustrative and exemplary in nature only and not as restrictive.

### BRIEF DESCRIPTION OF THE DRAWINGS

While the specification concludes with claims particularly pointing out and distinctly claiming the present invention, it is believed that the same will be better understood from the following description taken in conjunction with the accompanying drawings in which:

FIG. 1 is a schematic view of an exemplary manual production pacemaker in accordance with the present invention;

FIG. 2 is a schematic view of an exemplary pacemaker and data reading device of the present invention, wherein the data reading device displays information received from the pacemaker;

FIG. 3 is a schematic view of an alternative embodiment of an exemplary manual production pacemaker in accordance with the present invention;

FIG. 4 is a schematic view of another alternative embodiment of an exemplary manual production pacemaker in accordance with the present invention;

FIG. 5 is a perspective view of yet another alternative embodiment of an exemplary manual production pacemaker in accordance with the present invention; and

FIG. 6 is a schematic plan view of a production line employing an exemplary manual production pacemaker system of the present invention.

### DETAILED DESCRIPTION OF EXEMPLARY EMBODIMENTS

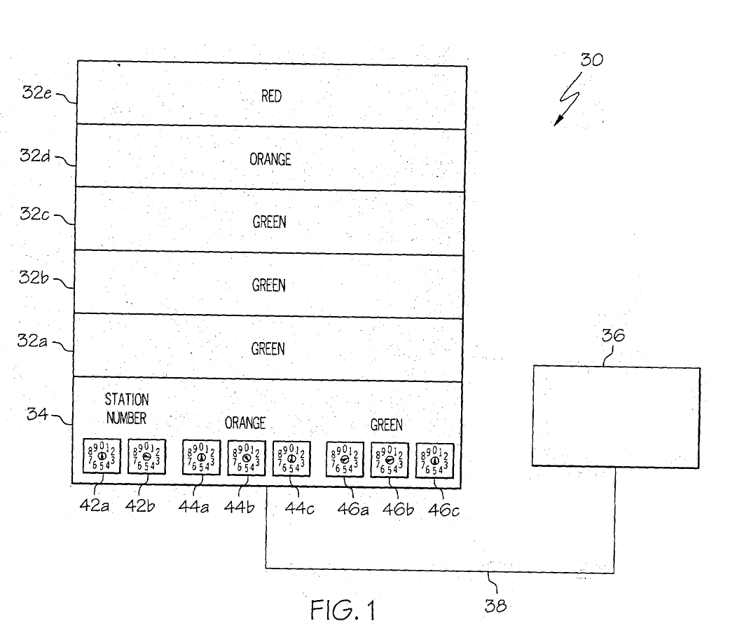

Referring to the drawing figures in detail, wherein like numerals indicate the same elements throughout the drawing figures, FIG. 1 illustrates an exemplary manual production pacemaker 30 in accordance with the present invention. Pacemaker 30 may be located adjacent to a worker in a work cell or production line work area. As referenced herein, “adjacent to” may include, but is not limited to near the worker, within sensory access by a worker, on a work tool, integrated in a wrist watch type device, integrated in safety glasses, or the like.

Pacemaker 30 may comprise a sensory output shown here as including a plurality of light segments 32a-32e vertically arranged in a column extending from a base 34. The pacemaker 30 may be connected to a computer 36 or other data reading and/or control device such as through a serial cable, RS-232 or other communication arrangement 38. As described later herein, the worker is paced through a production cycle through illumination of the various light segments 32a-32e.

In the embodiment of FIG. 1, the light segments 32a-32e include a first green light segment 32a, a second green light segment 32b, a third green light segment 32c, a first orange light segment 32d and a first red light segment 32e. As described later, however, these light segments can be arranged in any number of configurations including any number of colors, and one or more of the light segments may be omitted from the pacemaker 30. Of course, it is also possible to add additional light segments, such as, for example, an additional green light segment, orange light segment and/or red light segment.

In FIG. 1, each light segment 32a-32e may be housed in a plastic shell and may be generally circular in shape. In another embodiment, each light segment may be constructed of any transparent material and can exist in any shape including, but not limited to a square, rectangle or polygon. Each light segment 32a-32e may also comprise a light positioned within each light segment to illuminate each segment. It should be understood that a “light,” as referenced herein, may include any device capable of providing varying visual sensory cues including, but not limited to a bulb, LED, optic, etc.

The light may be a clear or colored bulb depending on the color of the plastic that comprises each segment. For example, if the first green light segment 32a comprises green colored plastic shell, then the bulb positioned within the light segment 32a may be clear. Alternatively, if the first light segment 32a comprises a clear plastic shell, then the bulb positioned within the light segment may be green. In addition, as discussed below, multi-color LED's may be used as an alternative to the plastic shell/inner bulb configuration.

The exemplary base 34 may be similar in shape and size to light segments 32a-32e and include a plurality of dial switches 42a-42b, 44a-44c and 46a-46c positioned at any location about the base. The switches may be set or turned with, for example, a flat head screw driver or any other appropriate apparatus. Dial switches 42a-42b may be used to designate the particular station number where the pacemaker 30 is positioned, whereas switches 44a-44c and 46a-46c can be used to set the desired task achievement period for completion of a cycle. However, it should be understood that the base may comprise any number of dial switches configured to set a variety of functions and/or light segments. Also, it is contemplated that the task achievement period may be set in a variety of ways other than by dial switches including, but not limited to uploading data into a processor, push buttons and/or other digital inputs.

FIG. 1 illustrates an example where switch 42a is turned to the “0” position and switch 42b is turned to the “3” position. As such, pacemaker 30 is at station number 03. As described later, identity of the station number may be important for differentiating recorded information among various pacemakers 30 in a system having a plurality of such devices.

The various light segments 32a-32e may be illuminated bottom to top and scaled according to the task achievement period set by dial switches 44a-44c and 46a-46c. As referenced in this example, “scaled” may mean that the task achievement period set by dial switches 44a-44c and 46a-46c is presented in relative portions for easy real time recognition of time used vs. time remaining status. A micro controller located in the base 34 may be programmed with an algorithm to scale and implement information set by dial switches 44a-44c and 46a-46c regarding the desired task achievement period. In another embodiment, the computer 36 or PLC may scale and implement information set by the dial switches or other data entry devices.

In the illustrated example in FIG. 1, the task achievement period has been set at 160 seconds for illustrative purposes. For example, switch 44a is turned to the “0” position, switch 44b is turned to the “4” position and switch 44c is turned to the “0” position. As such, orange light segment 32d may be set for 40 seconds. In addition, switch 46a is turned to the “1” position, switch 46b is turned to the “2” position and switch 46c is turned to the “0” position. As such, green light segments 32a-32c may be set for 120 seconds total. The micro controller described above may scale the time set by dial switches 46a-46c equally among the three green light segments 32a-32c (e.g. 40 seconds for 32a, 40 seconds for 32b and 40 seconds for 32c). Therefore, in this example, the desired task achievement period is set at 160 seconds (40 seconds orange+120 seconds green=160 seconds for task achievement period).

While the task achievement period in this example is set at 160 seconds, it should be understood that the time that can be set by the orange switches 44a-44c for orange light segment illumination may vary from 0-999 seconds. Similarly, the time set by the green switches 46a-46c may vary from 0-999 seconds. In another embodiment, any number of dial switches may be added to set any amount of time.

By appropriately setting the colored light segments in this way, any total task time period can be scaled into the device by the algorithm programmed in the micro controller, with relative portions of the period being divided for display in lights of different colors by the time segments dialed in. If desired, the task achievement period may be adjusted by turning one or more dial switches to the desired position. The change may be implemented in real time or with the next start signal input.

Continuing with this example, a cycle commences upon reception of a start signal (i.e. 24V power input). The start signal may be triggered by a manual input initiated by the worker at the production line, automatically by sensing of a part by a proximity or limit switch as it moves into or out of a worker's zone, or through any other sensing and/or control device. The commencement of the cycle triggers illumination of the first green light segment 32a. Upon expiration of 40 seconds, second green light segment 32b illuminates. Upon expiration of 80 seconds, third green light segment 32c illuminates. Upon expiration of 120 seconds, first orange light segment 32d illuminates and upon expiration of 160 seconds, red light segment 32e illuminates. Illumination of the red light segment 32e indicates termination of the time for the task achievement period (e.g. termination of 160 seconds). In another embodiment having multiple red light segments, illumination of the first red light segment may trigger the beginning of the termination of the cycle.

Thus, the pacemaker 30 of the present invention provides varying visual cues through illumination of the various light segments 32a-32e and may be scaled according to the task achievement period set by the various dial switches 44a-44c and 46a-46c. If desired, additional varying cues may be achieved by providing several operational phases for each light segment 32a-32e (e.g. slow blinking, faster blinking, fastest blinking and “full on” color). This feature may be implemented, for example, by the algorithm stored within the micro controller or other such control device.

For example, referring to FIG. 1, and continuing with the aforementioned example, upon commencement of a cycle, the first green light segment 32a may commence to a slow blinking illumination. After 10 seconds, the first green light segment 32a may further increase to a faster blinking illumination. After 20 seconds, the first green light segment 32a may further increase to an ultra-fast blinking illumination and after 30 seconds may be “full on” illuminated. Upon expiration of 40 seconds (the amount of time preset for each of the three green light segments by switches 46a-46c), the second green light segment 32b may commence a slow blinking illumination. This process may continue until the red light segment 32e is illuminated indicating termination of the task achievement period (e.g. expiration of 160 seconds).

There may be instances when a production process requires more than one step, and thus, may require more than one task achievement period. As such, while multiple pacemakers could be used, it is contemplated that the present invention is capable of setting multiple task achievement periods wherein each task achievement period is associated with one or more light segments 32a-32e. More specifically, where a particular production process requires four steps, the pacemaker may be scaled to the task achievement period by setting individual light segments each for a process, or by setting the total time into a micro controller or processor (which would then scale the time to the light segments available or chosen).

For example, as illustrated in FIG. 1, dial switches 44a-44c and 46a-46c may be set so that each of light segments 32a-32d is scaled to each of the four steps. If each step of the four step process would ordinary take 40 seconds/step, four task achievement periods may be set by setting the green switches 46a-46c for 120 seconds (120 seconds/3 green light segments=40 seconds per green light segment) and the orange switches 44a-44c for 40 seconds (as illustrated in FIG. 1). As such, upon commencement of the cycle, the first green light segment 32a may be illuminated triggering the start of the first task achievement period. Upon expiration of 40 seconds (e.g. termination of the first task achievement period), the second green light segment 32b may illuminate triggering the start of the second task achievement period (the worker is aware that the first step should be completed). This process continues until the red light segment illuminates triggering termination of the cycle (e.g. all four task achievement periods). By sensing the varying cues (e.g. light color, number of lights, display mode of the lights, etc.) a worker can always know where he/she is in completing the task(s) on time.

As previously stated, the cycle is completed when the task achievement period has expired. If the worker completes his work prior to expiration of the task achievement period, however, the pacemaker 30 may restart the cycle upon manual input by the worker at the production line, sensing of a part by a proximity or limit switch as it enters and/or leaves the worker's station, or any other sensing and/or control device. Consequently, a worker exceeding productivity goals will not be hampered and the system will facilitate productivity improvements and monitor that progress (where data feedback is used). Alternatively, should the worker need to stop the work in the middle of a cycle, it is contemplated that the pacemaker 30 may be paused and restarted at the light segment where it left off by pressing a push button or other such device.

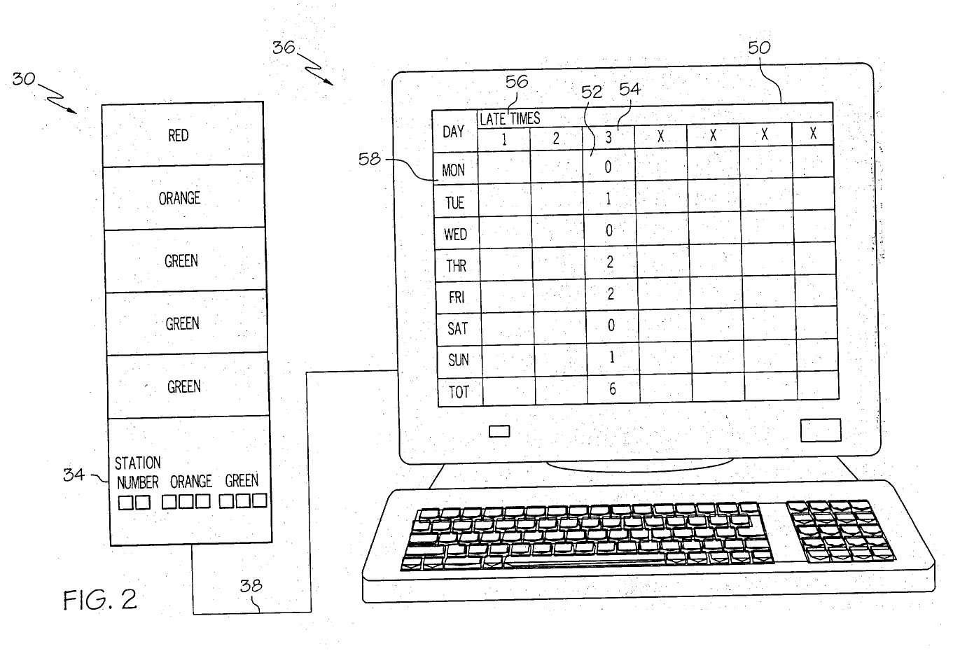

Another feature of the present invention is that information relating to the pacemaker may be recorded and/or displayed on a computer or other such data reading device. Such information may be useful such as to assist a production line coordinator in determining which stations and/or workers require additional time to complete a particular production process, where critical processes need to be changed or improved, or to identify and reward particularly productive workers. Referring to FIG. 2, information relating to the pacemaker 30 might be sent via serial line 38 to computer 36. The pacemaker 30 may communicate with the computer 36 through an RS-232 serial line 38 connected to an RS-232C port located in the base of the pacemaker 30. In another embodiment, any communication device may be used to communicate information from the pacemaker 30 to the computer 36 or any other data reading/display device. Also, it is contemplated that wireless technology may be used to communicate information from the pacemaker 30 to the computer 36.

Information relating to the pacemaker 30 transmitted to the computer 36 may include, but is not limited to, the station number 54 where the pacemaker 30 is positioned, the number of cycles resulting in illumination of the red light segment 56 (i.e. equally or exceeding the maximum time allotted for the task), the day of the week 58, the number of light segments illuminated per cycle (i.e. tasks completed prior to full allotted time), pauses of the pacemaker operation and duration and the overall time required by a worker to complete each cycle.

In the example illustrated in FIG. 2, the exemplary display screen 50 illustrates the number of times per day 52 that the pacemaker 30 positioned at various stations 54 terminates a cycle by illumination of the red light segment 56, otherwise indicated as “Late Times.” The late times may be recorded per day with the total number of late times 52 indicated at the bottom of the screen 50. In this particular example, the pacemaker 30 transmits information to the computer 36 via serial line 38 that the particular pacemaker 30 is set at station “3” (as also indicated in FIG. 1). As illustrated on the display screen 50, the worker at station 3 completed all cycles without red light segment illumination on Monday, Wednesday and Saturday, but failed to complete all cycles without red light segment illumination on Tuesday, Thursday, Friday and Sunday. As such, the worker at station 3 failed to complete the particular production process within the task achievement period six times through the week. This could indicate a problem with the needed time to complete a task, equipment failures, interruptions of the process, or worker inefficiencies, which need to be addressed. A variety of additional information regarding the production process may be recorded and displayed in a similar fashion.

Accordingly, the pacemaker of the present invention may be implemented by a method of first providing the pacemaker described herein and setting the dial switches to a desired task achievement period. As previously indicated, the task achievement period may be set in a variety of ways other than by dial switches such as uploading data into a processor, push buttons and/or other digital inputs. Once the task achievement period is set, the cycle may commence upon a manual input initiated by the worker at the production line, automatically by sensing of a part by a proximity of limit switch as it moves into or out of a worker's zone, or through any other sensing and/or control device. Throughout the cycle, the pacemaker may provide varying sensory cues corresponding to relative portions of the achievement period set by the dial switches. Upon completion of the cycle (either by termination of cycle time or by early completion signal), the pacemaker may stop and restart a subsequent cycle. A variety of information relating to the pacemaker and the completed task may be provided to a computer or other data reading device.

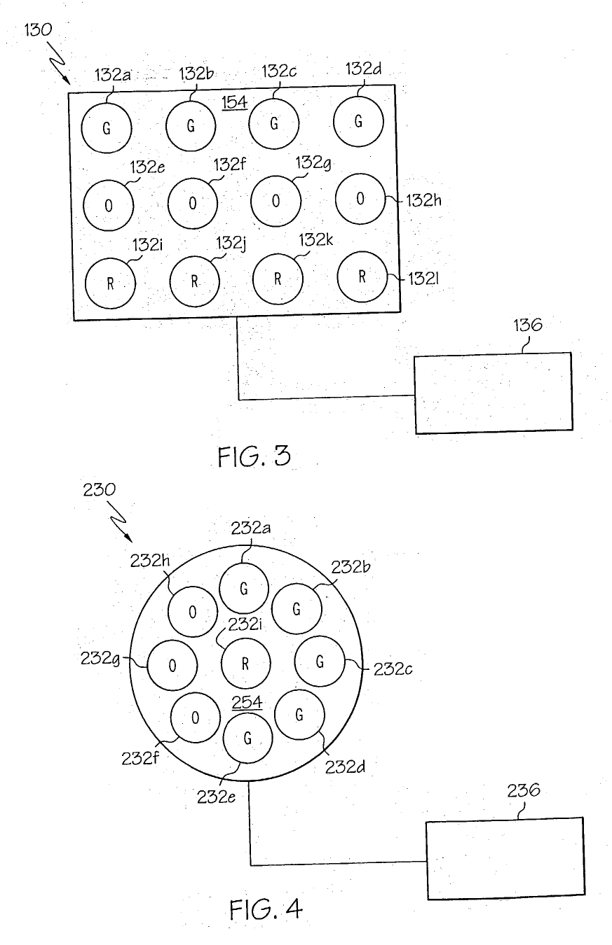

As previously discussed, the pacemaker of the present invention may be implemented in a variety of different embodiments. Examples of three such embodiments are illustrated in FIGS. 3-5. In FIG. 3 the pacemaker 130 comprises a plate 154 with a plurality of lights 132a-132l arranged in three horizontal rows. The first row includes a series of green lights 132a-132d, the second row comprises a series of orange lights 132e-132h, and the third row comprises a series of red lights 132i-132l. Each light 132a-132l may comprise a light bulb. In another embodiment, each light 132a-132l may be a multi-colored LED to allow, for example, virtually unlimited modification of light segment configurations.

The amount of time for the desired task achievement period may be set by one or more dial switches as in FIG. 1, or from a remote location such as by a remote input device, computer 136 or a PLC. For example, if the desired task achievement period was set at 120 seconds, the illumination of the lights in each row might be scaled to approximately 40 seconds (120 seconds/3 rows=40). As illustrated in FIG. 3, the lights 132a-132l are arranged according to the amount of time remaining in the task achievement period. Upon commencement of the cycle, the first green light 132a may illuminate for ten seconds followed by illumination of second green light 132b. After expiration of 20 seconds the third green light 132c may illuminate for ten seconds. After expiration of 40 seconds the first orange light 132e may illuminate for ten seconds. Upon expiration of 80 seconds the first red light 132i may illuminate for ten seconds and so on until termination of the task achievement period is indicated. In the exemplary embodiment of FIG. 3, termination of the task achievement period may be indicated by intermittent flashing of all lights 132a-132l displayed by pacemaker 130 until restart upon commencement of the next cycle. As discussed above, if desired, additional varying cues may be included by providing several operational phases for each light segment 132a-132l (e.g. slow blinking, faster blinking, fastest blinking and solid color). As will be understood, if the sensory cues were to be available, varying sounds, rate or mode of presentation, volume and the like could be similarly varied for providing an easily identifiable indication of relative portions of the preset task achievement period. Also, similar to pacemaker 30 in FIG. 1, pacemaker 130 of FIG. 3 may transmit information relating to the pacemaker to a computer 136 or other such data reading/display device.

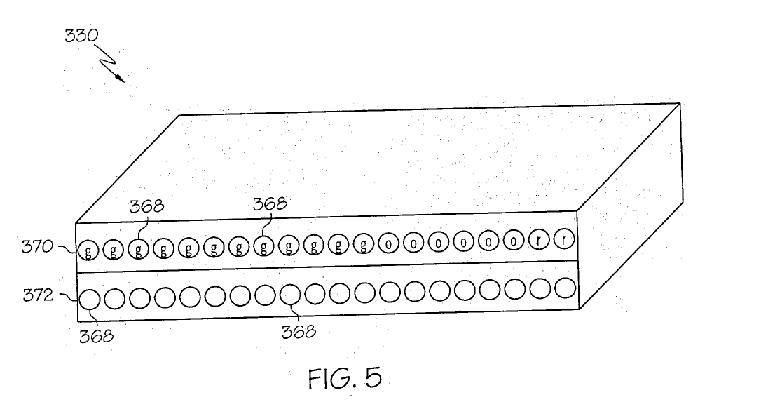

Referring to FIG. 4, another exemplary embodiment of a pacemaker 230 is shown and illustrated. Pacemaker 230 comprises a plate 254 with a plurality of lights 232a-232i arranged in a circular formation. The outer circle comprises a series of green lights 232a-232e and a series of orange lights 232f-232h. A single red light 232i located in the center of the outer circle. Each light 232a-232i may comprise a light bulb. In another embodiment, each light 232a-232i may be a multi-colored LED.

The amount of time for the desired task achievement period may be set by one or more dial switches as in FIG. 1, or from a remote location such as by a computer 236 or a PLC. For example, if the desired task achievement period was set at 120 seconds, the illumination of the outer circle lights 232a-232i would be scaled to approximately 15 seconds (120 seconds/8 outer circle lights=15). Upon commencement of the cycle, the first green light 232a may illuminate for fifteen seconds followed by illumination of second green light 232b. After expiration of 30 seconds, the third green light 232c may illuminate for fifteen seconds. After expiration of 75 seconds the first orange light 232f may illuminate for fifteen seconds. Upon expiration of 105 seconds the last orange light 232h may illuminate for fifteen seconds when termination of the task achievement period is indicated by illumination of the red light 232i. Similar to other embodiments discussed herein, additional varying cues may be achieved by providing several operational phases for each light segment 132a-132l (e.g. slow blinking, faster blinking, fastest blinking solid color). Also, similar to pacemaker 30 in FIG. 1, pacemaker 230 of FIG. 4 may transmit information relating to the pacemaker to a computer 236 or other such data reading/display device.

FIG. 5 illustrates yet another embodiment of a pacemaker 330 in accordance with the present invention. The pacemaker 330 may be generally rectangular in shape and may lay horizontally adjacent a worker at the particular work station. The pacemaker 330 may comprise an upper 370 and lower 372 horizontal row of multi-color LED lights 368. In one embodiment, the LED colors may comprise green, orange and red. The ratio of each color displayed by each LED 368 in the upper row 370 depends on the amount of time set for the task achievement period. More specifically, the preset time for the green, orange and red LED's of the upper row 370 of this example may be set individually (e.g. with dial switches as in FIG. 1 or from a remote location such as with a remote controller, computer, PLC or other control device) and the total time is illustrated along the entire upper row 370. Thus, the upper row 370 of the pacemaker 330 functions on a scale wherein the LED's change color and respond to the amount of time set.

For example, if the task achievement period is set for a total of 100 seconds wherein the green range is set for 60 seconds, the orange range for 30 seconds, and the red range for 10 seconds, then the upper horizontal row 370 color distribution from left to right is 60% green (12 LED's as illustrated in FIG. 5), 30% orange (6 LED's as illustrated in FIG. 5) and 10% red (2 LED's as illustrated in FIG. 5). The color distribution of LED 368 may be scaled up by a micro controller (discussed above), a computer, or a PLC according to the amount of time set for the task achievement period. Therefore, intervals of lighting length of each color may vary.

The lower row 372 may illuminate from left to right, green to orange to red accordingly to the amount of time remaining in the task achievement period. Continuing with the example set forth above, if the task achievement period is set for a total of 100 seconds, upon commencement of the cycle, the green range (12 LED's as illustrated in FIG. 5) will sequentially and uniformly illuminate from left to right for 60 seconds (e.g. 1 every 5 seconds). Upon expiration of 60 seconds, the orange range (6 LED's as illustrated in FIG. 5) will similarly sequentially illuminate from left to right for 30 seconds followed by illumination of the red range (2 LED's as illustrated in FIG. 5) for 10 seconds. In this way, the sensory cues (in this example LED lights) provide a worker with an easily recognizable and logical presentation of relative portions of the preset period (e.g. time used and/or time remaining). The worker can easily compare the progression of the illuminated LED's in the lower row 372 to the upper row 370 in a sensory manner with little or no requirement for distracting mental processing.

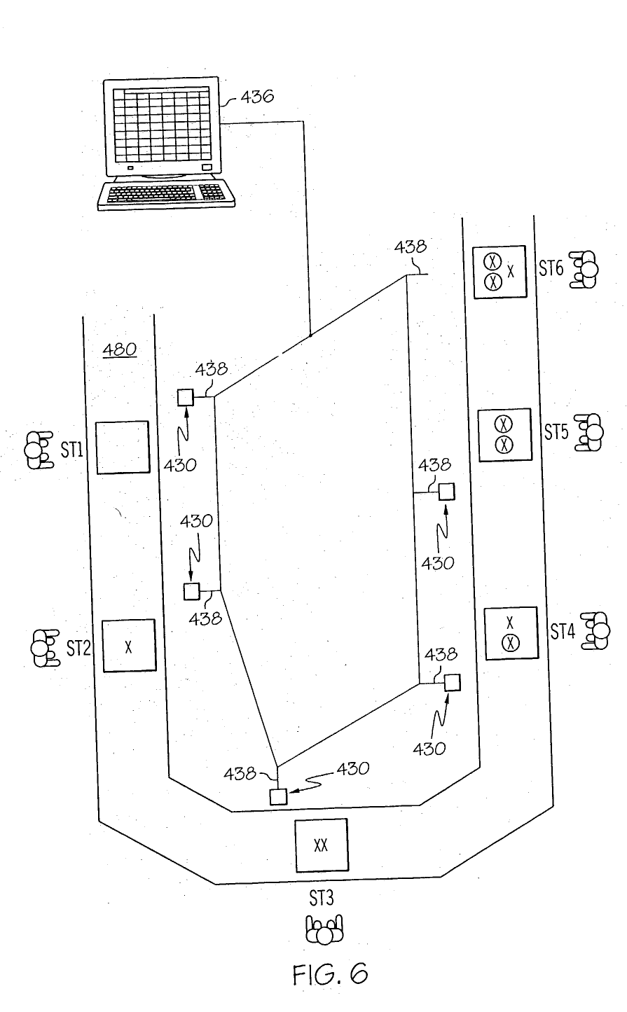

Another aspect of the present invention is that a plurality of pacemakers may be stationed adjacent a worker at a variety of locations within a production plant, and in addition to pacing individual workers during a production cycle, may provide information regarding efficiency and effectiveness of the entire production process within a production plant. FIG. 6 illustrates a simple exemplary production plant with a plurality of pacemakers 430 of the present invention positioned adjacent workers at a variety of stations ST1-ST5 along a production line 480. As illustrated in FIG. 6, all of the pacemakers 430 may be interfaced via a serial cable 438 or other communication arrangement, with a central computer 436 or other data reading device capable of receiving, manipulating and sending data. In another embodiment, each pacemaker 430 may be interfaced to a separate data reading device.

As previously discussed, computer 436 may receive information transmitted by the pacemakers 430 relating to the station number where the pacemaker 430 is positioned, the number of cycles terminating in illumination of the red light segment, the day of the week, the number of segments illuminated per cycle, the number of segments illuminated per production process and the overall time required by a worker to complete each cycle. In addition, computer 436 may manipulate, analyze, report, sort and/or store data for interpretation of effectiveness and efficiency of the production line process. However, it should be understood that computer 436 may also control the production process by setting and/or adjusting the task achievement periods, either in real time or after completion of a cycle. The computer's ability to set and/or adjust the task achievement period may replace the need for dial switches (discussed above, see FIG. 1) or may work in conjunction with the dial switches, remote devices (e.g. a PDA) or a PLC to adjust or reset the task achievement period for each pacemaker 430 according to data received from the pacemakers 430 regarding the production process. Modification of set times and sensory cue presentation schemes might also be desirable where a new assembly station is added, or if improvements or changes are made to existing manufacturing processes or work stations.

FIG. 6 illustrates pacemakers 430 positioned at stations ST1-ST5. While station ST6 does not have a pacemaker 430, an additional pacemaker 430 may be added to the system and interfaced with the computer 436 by connecting the additional pacemaker to the serial line 438 or via other communication linkage. Alternatively, a pacemaker 430 may be removed from one of stations ST1-ST5 and set up at station ST6. For example, if the pacemaker illustrated in FIG. 1 is moved from station ST3 to station ST6 in FIG. 5, a worker need simply disconnect serial line 438 at station ST3, move the pacemaker 430 to station ST6, adjust the dial switches 42a-42b (FIG. 1) to station number “06,” and plug in serial line 438 at station ST6. In another embodiment, pacemaker 430 may be automatically adjusted to its new station when tied into the system.

Pacemaker 430 may be mounted directly to the production line 480, or in another embodiment, may be free standing from a support base. The flexibility of the pacemaker and system of the present invention provides for easy disconnection at one station and reconnection at another station.

It is contemplated that the present design may be manufactured on a much smaller scale. For example, the pacemaker may be manufactured so that it fits within or otherwise works in conjunction with a users safety glasses (e.g., a “heads up” display), or a wrist watch type of unit. In another embodiment, the pacemaker may be manufactured in conjunction with one or more tools used by the assembly line worker, or otherwise configured for easy selective attachment to such a tool, for quick viewing of the pacemaker. As mentioned above, it is also contemplated that proportional pacemaking providing varying cues scaled to a task achievement period could be provided in other (non-lighting) ways or in addition to the lights. For example, an ear bud could provide audible pacemaking, or a vibrating unit might provide physical stimulation pacemaking. Such alternative sensory arrangements might be used instead of or in addition to visual sensory cues to accommodate a variety of preferences, working environments and worker disabilities. As such, the pacemaker of the present invention may provide any type of sensory output (visual, audible or physical) of varying sensory cues scaled to a desired task achievement period.

The foregoing description of the various embodiments of the invention has been presented for the purposes of illustration and description. It is not intended to be exhaustive or to limit the invention to any of the precise forms or process disclosed. Many alternatives, modifications and variations will be apparent to those skilled in the art of the above teaching. For example, the pacemaker and system in accordance with the present invention may comprise pacemakers of varying sizes, shapes configured to provide a variety of sensory cues. Accordingly, while some of the alternative embodiments of the pacemaker and system have been discussed specifically, other embodiments will be apparent or relatively easily developed by those of ordinary skill in the art. Accordingly, this invention is intended to embrace all alternatives, modifications and variations that have been discussed herein, and others that fall within the spirit and broad scope of the claims.

What is claimed is:

1. A pacing apparatus for use in a manual production line comprising a sensory output configured to provide varying sensory cues selectively scaled to a desired task achievement period and corresponding to relative portions of said achievement period.

2. The pacing apparatus of claim 1, wherein said sensory cues comprise visual cues.

3. The pacing apparatus of claim 1, wherein said sensory cues comprise audible cues.

4. The pacing apparatus of claim 1, wherein said sensory cues comprise physical cues.

5. The pacing apparatus of claim 1, wherein said sensory output comprises a plurality of lights sequentially arranged according to said desired task achievement period.

6. The pacing apparatus of claim 5, wherein at least some of said plurality of lights are configured to display light colored differently than light from one or more of said lights.

7. The pacing apparatus of claim 5, wherein said plurality of lights comprise at least one green light and at least one red light.

8. The pacing apparatus of claim 7, wherein said green light indicates a commencement or early portion of said task achievement period and said red light indicates a later or termination portion of said task achievement period.

9. The pacing apparatus of claim 5, wherein each of said plurality of lights is selectively activated to correspond to a relative portion of said task achievement period.

10. The pacing apparatus of claim 9, wherein each of said plurality of lights is intermittently illuminated and the amount of time between each illumination decreases as time remaining for said segment decreases to sensorily display said relative portions of said achievement period.

11. The pacing apparatus of claim 1, wherein said sensory output comprises a plurality of dial switches configured to set said task achievement period.

12. The pacing apparatus of claim 1, wherein said sensory output is further configured to provide data to a data reading device.

13. The pacing apparatus of claim 1, wherein said sensory output is further configured to receive data for presenting said sensory cues corresponding to said desired task achievement period.

14. The pacing apparatus of claim 1, wherein said sensory output is further configured to restart the pacing apparatus for a subsequent task after a previous task has been completed.

15. A pacing apparatus for use in a manual production line comprising a sensory display having a plurality of lights, said sensory display configured to selectively provide varying visual cues scaled to a desired task achievement period and corresponding to relative portions of said achievement period.

16. The pacing apparatus of claim 15, wherein said plurality of lights are sequentially arranged according to said desired task achievement period.

17. The pacing apparatus of claim 15, wherein at least some of said plurality of lights are configured to display light colored differently than light from one or more of said lights.

18. The pacing apparatus of claim 15, wherein said plurality of lights comprise at least one green light and at least one red light.

19. The pacing apparatus of claim 18, wherein said green light indicates a commencement or early portion of said task achievement period and said red light indicates a later or termination portion of said task achievement period.

20. The pacing apparatus of claim 15, wherein each of said plurality of lights is selectively activated to correspond to a relative portion of said task achievement period.

21. The pacing apparatus of claim 20, wherein each of said plurality of lights is intermittently illuminated and the amount of time between each illumination decreases as time remaining for said segment decreases.

22. The pacing apparatus of claim 15, wherein said sensory display comprises a plurality of dial switches configured to set said task achievement period.

23. The pacing apparatus of claim 15, wherein said sensory display is further configured to provide data to a data reading device.

24. The pacing apparatus of claim 15, wherein said sensory display is further configured to receive data for presenting said visual cues corresponding to said desired task achievement period.

25. A system for pacing workers in a manual production line comprising:
a) means for entering data corresponding to a desired task achievement period; and
b) means for providing varying sensory cues scaled to said desired task achievement period and corresponding to relative portions of said achievement period.

26. The system for pacing workers of claim 25, further comprising means for restarting said system for a subsequent task after a previous task has been completed.

27. The system for pacing workers of claim 25, further comprising means for compiling information relating to said sensory output.

28. The system for pacing workers of claim 25, wherein said means for entering data comprises a dial switch.

29. The system for pacing workers of claim 25, wherein said means for providing varying sensory cues comprises a plurality of lights sequentially arranged according to said desired task achievement period.

30. The system for pacing workers of claim 29, wherein at least some of said plurality of lights are configured to output light colored differently than light from one or more of said lights.

31. The system for pacing workers of claim 29, wherein said plurality of lights comprise at least one green light and one red light.

32. The system for pacing workers of claim 29, wherein said green light indicates a commencement or early portion of said task achievement period and said red light indicates a later or termination portion of said task achievement period.

33. The system for pacing workers of claim 29, wherein each of said plurality of lights is selectively activated to correspond to a relative portion of said task achievement period.

34. The system for pacing workers of claim 33, wherein each of said plurality of lights is intermittently illuminated and the amount of time between each illumination decreases as time remaining for said segment decreases.

35. A method for pacing a manual production task such as in a manufacturing production line, said method comprising the steps of:
a) providing a pacing apparatus comprising a sensory output configured to provide varying sensory cues scaled to a desired task achievement period;
b) setting the sensory output to provide particular varying sensory cues corresponding to particular relative portions of said achievement period;
c) starting the pacing apparatus at the commencement of said production task;
d) providing varying sensory cues corresponding to said relative portions of said achievement period, whereby a worker can sense where in said period he or she is relative to how much work remains to complete said production task; and
e) stopping said pacing apparatus upon completion of said production task.

36. The method for pacing a manual production task of claim 35, further comprising the step of receiving data for setting said sensory output to provide particular varying sensory cues corresponding to particular segments of a task achievement period.

37. The method for pacing a manual production task of claim 35, further comprising the step of providing data to a data reading device regarding a completed task.

38. The method for pacing a manual production task of claim 35, further comprising the step of restarting the pacing apparatus for a subsequent task after a previous task has been completed.
